(19) United States
(12) Patent Application Publication
(10) Pub. No.: US 2025/0345223 A1
(43) Pub. Date: Nov. 13, 2025

(54) Patient Transport Systems and Methods

(71) Applicant: UWM Research Foundation, Inc., Milwaukee, WI (US)

(72) Inventors: William David Perry, Delafield, WI (US); Jacob R. Rammer, Mequon, WI (US); Pilhwan Kim, Milwaukee, WI (US)

(21) Appl. No.: 19/204,010

(22) Filed: May 9, 2025

Related U.S. Application Data
(60) Provisional application No. 63/644,931, filed on May 9, 2024.

(51) Int. Cl. A61G 7/10

(52) U.S. Cl. CPC A61G 7/1026; A61G 7/103

(57) ABSTRACT

A patient transport system includes a transport support extending between a first location and a second location, and a transport device positioned on the transport support. The transport device slides along a surface of the transport support between the first location and the second location. The transport device includes a first inflatable chamber, a second inflatable chamber, and a threshold arranged between the first and second inflatable chambers. The threshold retains a patient between the first and second inflatable chambers during movement of the transport device along the surface of the transport support, between the first location and the second location.

### CROSS-REFERENCE TO RELATED APPLICATIONS

This application claims the benefit of U.S. Provisional Application No. 63/644,931, filed May 9, 2024, which is hereby incorporated by reference in its entirety.

### BACKGROUND

Patients (e.g., bariatric patients) with a larger body mass may be difficult to transport (e.g., from a bed to a stretcher). Further, current devices and methods for the transport of bariatric patients may place a large amount of force on health workers (e.g., EMTs, nurses, etc.), which may increase a risk of injury to the workers.

### SUMMARY

According to one aspect of the present disclosure, a patient transport system can include a transport support extending between a first location and a second location. A transport device can be positioned on the transport support, the transport device can slide along a surface of the transport support between the first location and the second location. The transport device can include a first inflatable chamber, a second inflatable chamber, and a threshold arranged between the first and second inflatable chambers. The threshold can retain a patient between the first and second inflatable chambers during movement of the transport device along the surface of the transport support, between the first location and the second location.

In some examples, the transport support can be inflatable.

In some examples, the transport device can further include handles attached to the transport device to facilitate movement of the transport device along the transport support.

In some examples, the first and second inflatable chambers can each include a panel forming an angle with respect to a surface of the transport device when inflated.

In some examples, the angle formed by the panels can be between about 15 and about 60 degrees when the chambers are inflated.

In some examples, the patient transport system can further include a retention system to secure the transport support to at least one of the first location or the second location.

In some examples, the transport device can include a surface material configured to reduce friction between the surface of the transport device and the surface of the transport support.

In some examples, the first inflatable chamber and the second inflatable chamber can be independently inflatable.

In some examples, each of the first inflatable chamber and the second inflatable chamber can include a port to permit inflation and deflation of the respective chamber.

According to another aspect of the present disclosure, a method of transferring a patient between a first location and a second location can include positioning a transport support beneath the patient, the transport support extending between the first location and the second location. The method can include placing a transport device on the transport support, beneath the patient, the transport device having first and second inflatable chambers separated by a threshold. The method can include positioning the patient on the threshold of the transport device, inflating the first and second chambers to secure the patient within a valley formed between the first and second chambers, and sliding the transport device along a surface of the transport support from the first location to the second location.

In some examples, the method can include inflating the transport support prior to moving the transport device.

In some examples, the method can include securing the transport support to at least one of the first location or the second location using a retention system.

In some examples, moving the transport device can include gripping one or more handles attached to the transport device and applying a force to slide the transport device along the surface of the transport support.

In some examples, the method can include deflating the first and second chambers and the transport support after moving the transport device to the second location.

In some examples, the first and second chambers can each include a panel forming an angle with respect to a surface of the transport device when inflated.

In some examples, the angle formed by the panels can be between about 15 and about 60 degrees when the chambers are inflated.

According to yet another aspect of the present disclosure, a patient transport system can include an inflatable transport support extending between a first location and a second location. A transport device can be movably positioned on the inflatable transport support. The transport device can include a first surface in contact with the inflatable transport support, first and second independently inflatable chambers, and a non-inflatable threshold between the first and second inflatable chambers. The threshold can retain a patient between the first and second inflatable chambers during movement of the transport device along the surface of the transport support, between the first location and the second location.

In some examples, the first and second independently inflatable chambers can each include a panel forming an angle with respect to the first surface of the transport device when inflated.

In some examples, the angle formed by the panels can be between about 15 and about 80 degrees when the chambers are inflated.

In some examples, the transport device can include a surface material configured to reduce friction between the surface of the transport device and the surface of the transport support.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of a patient transport device according to aspects of the present disclosure.

FIG. 2 is a side view of the patient transport device of FIG. 1 in a first position.

FIG. 3 is a perspective view of the patient transport device FIG. 1 in a second position.

FIG. 4 is a side view of the patient transport device of FIG. 3 in the second position.

FIG. 5 is a diagrammatic view of a patient transport process using the patient transport device of FIG. 1.

FIG. 6 is a perspective view of another example of a patient transport device.

FIG. 7 is a top view of the patient transport device of FIG. 6.

FIG. 8 is a side view of the patient transport device of FIG. 6.

FIG. 9 is a front view of the patient transport device of FIG. 6.

FIG. 10 is a diagrammatic view of an interior of a housing of the patient transport device of FIG. 6.

FIG. 11 is a perspective view of an interior of the housing of the patient transport device of FIG. 6.

FIG. 12 is a perspective view of a powertrain of the patient transport device of FIG. 6.

FIG. 13 is a flowchart of another example of a patient transport process using the patient transport device of FIG. 6.

FIG. 14 is an axonometric view of a patient transfer system according to aspects of the present disclosure.

FIG. 15 is an end view of the patient transfer system of FIG. 14.

FIG. 16 is an axonometric view of a first stage of a patient transfer process using the patient transfer system of FIG. 14.

FIG. 17 is an axonometric view of a second stage of a patient transfer process using the patient transfer system of FIG. 14.

FIG. 18 is an axonometric view of a third stage of a patient transfer process using the patient transfer system of FIG. 14.

FIG. 19 is an axonometric view of a fourth stage of a patient transfer process using the patient transfer system of FIG. 14.

FIG. 20 is an axonometric view of a fifth stage of a patient transfer process using the patient transfer system of FIG. 14.

FIG. 21 is an axonometric view of a sixth stage of a patient transfer process using the patient transfer system of FIG. 14.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

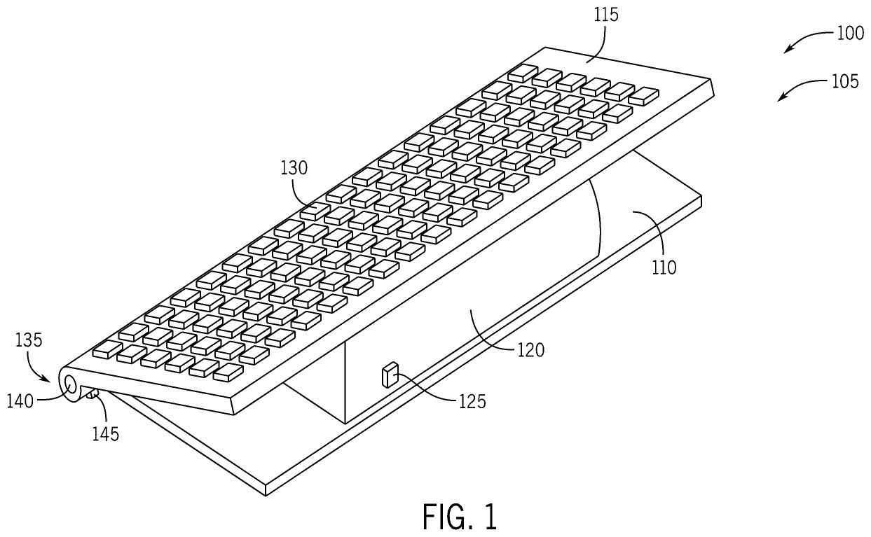

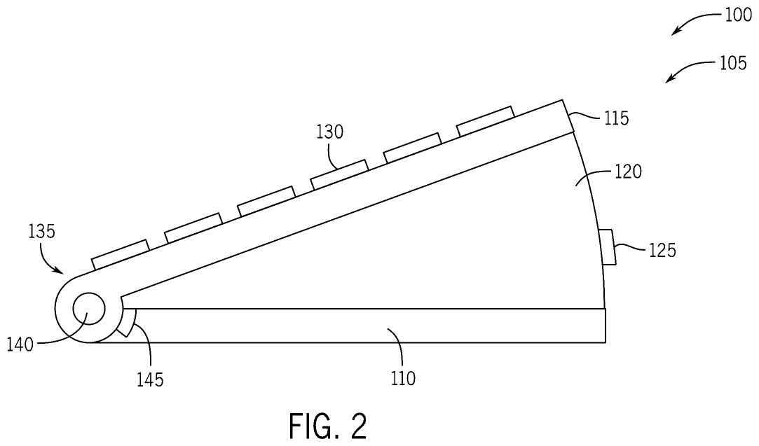

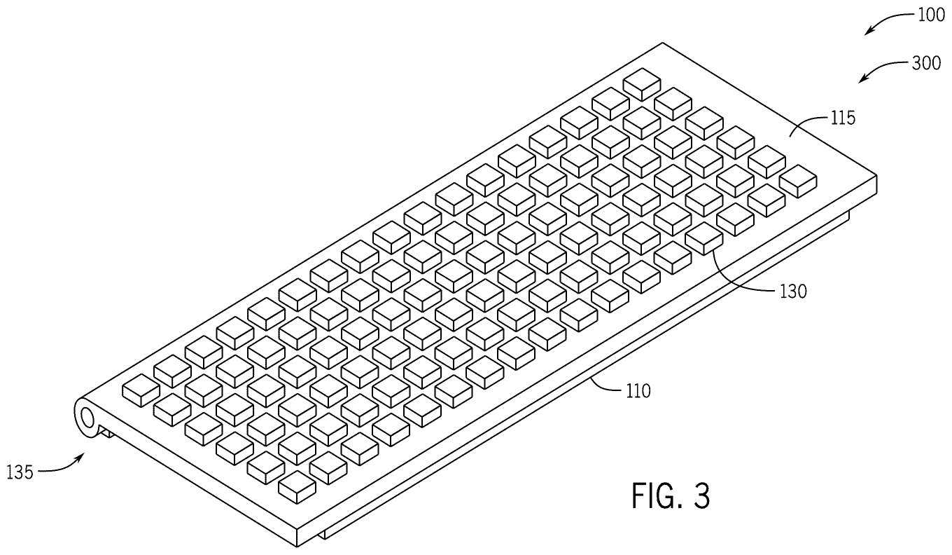

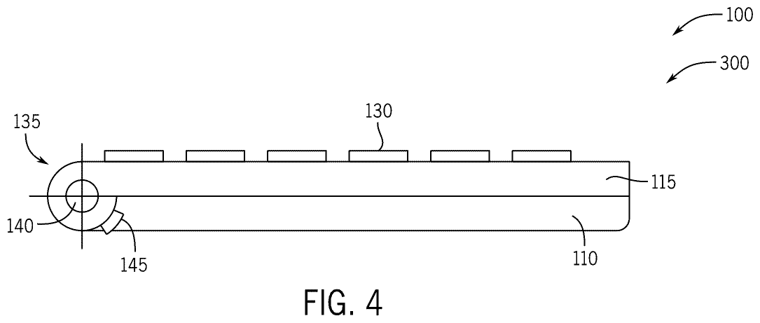

FIGS. 1-4 show examples of a patient transport device 100 in both a first position 105 (see, e.g., FIGS. 1 and 2) and in a second position 300 (see, e.g., FIGS. 3 and 4). The patient transport device 100 may be configured to transition between the first position 105 and the second position 300 in response to the inflation or deflation of a ramp 120 sandwiched between a first panel 110 and a second panel 115 of the patient transport device 100. In one example, the ramp 120 may be inflated via a port 125 (e.g., via manual inflation, a pump, or other inflation mechanisms) to transition the patient transport device 100 from the second position 300 to the first position 105.

The patient transport device 100 may transition between the second position 300 and the first position 105 in order to facilitate the transportation of a patient between a first location (e.g., a bed) and a second location (e.g., a stretcher). In one example, to permit the transition of the patient transport device 100 between the second position 300 and the first position 105, the first panel 110 and the second panel 115 may be connected together via a hinge 135. The hinge 135 may permit pivotal (e.g., rotational) movement of the second panel 115 (e.g., corresponding to a second surface of the ramp) with respect to the first panel 110 (e.g., corresponding to a first surface of the ramp).

The hinge 135 may be formed by a shaft 140 extending through portions of the first panel 110 and the second panel 115 at an end thereof. Further, to secure the shaft 140 in position, a fastener 145 may be arranged through a portion of the first panel 110 or the second panel 115 until an end of the fastener 145 contacts the shaft 140. Thus, the shaft 140 may be secured within a channel formed by overlapping portions of the first panel 110 and the second panel 115, while still permitting pivotal movement of the second panel 115 with respect to the first panel 110 (e.g., via inflation of the ramp 120).

To increase patient comfort during transportation the second panel 115 of the patient transport device 100 may include a pad 130, which may be made from a resilient material in order to provide increased comfort to the patient during transport. Further, to ensure patient safety, the dimensions of the patient transport device 100 may be arranged so that a length (e.g., longitudinally) of the patient transport device 100 may be configured to extend from about a head of a patient to about the feet of the patient. In one particular example, the patient transport device 100 may be about 72 inches in length. Further, the dimensions of the patient transport device 100 may be arranged so that a width of the patient transport device 100 may be configured to extend about the width of the body of the patient. In one particular example, the patient transport device 100 may be about 18 inches in length. In some examples, when fully inflated, the ramp 120 may position the second panel 115 at an angle of about 20 degrees with respect to the first panel 110. Correspondingly, when fully deflated, the second panel 115 may be positioned about parallel to the patient transport device 100.

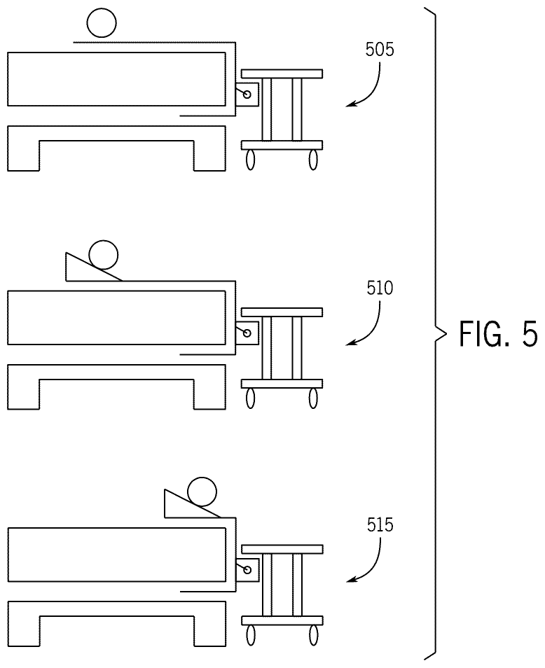

FIG. 5 illustrates an example of the patient transport device 100 in use. For example, at stage 505 the patient may be positioned on a bed, with a stretcher arranged next to (e.g., abutting, and parallel to) the bed. At this time, the patient may be flat on their back, awaiting transport to the stretcher. Further, to begin the transport process, an operator may position the patient transport device 100, in the second position 300, underneath the patient. In one example, the patient transport device 100 may be positioned under the patient with the hinge 135 arranged nearer the stretcher.

Following this, at stage 510, the operator may inflate the ramp 120 via the port 125. For example, the operator may inflate the ramp 120 via an air pump, manual pump, etc. As the ramp 120 inflates, the second panel 115 pivots about the hinge 135 and adjusts an angle of the second panel 115 with respect to the first panel 110, which may begin to raise (e.g., lift) the patient.

Once the patient transport device 100 is at the desired angle (e.g., ramp 120 fully or partially inflated), the operator may begin to apply force to a sheet, tarp, or other device to utilize the effects of gravity to begin to slide the patient down the second panel 115 of the patient transport device 100, which correspondingly results in lateral movement of the patient towards the stretcher. In some examples, due to the effects of gravity on the patient, the amount of force applied by an operator to move the patient may be about half of the amount of force usually required to move the patient. Thus, the risk of injury to the operator may be reduced.

In some examples, rather than utilize a separate sheet or tarp to move the patient, the patient transport device 100 may include an integrated sheet or tarp. For example, the sheet or tarp may be integrated into the second panel 115 of the patient transport device 100 (e.g., via hook- and -loop fasteners, a zipper mechanism, etc.).

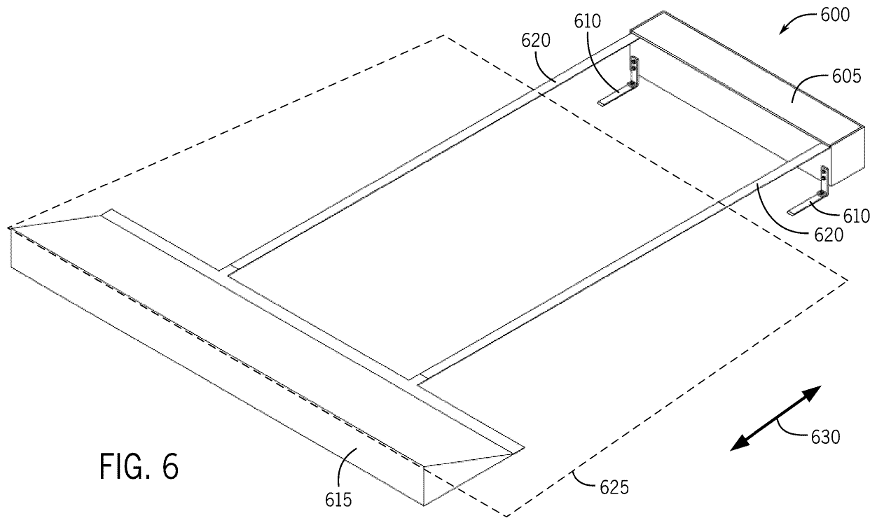

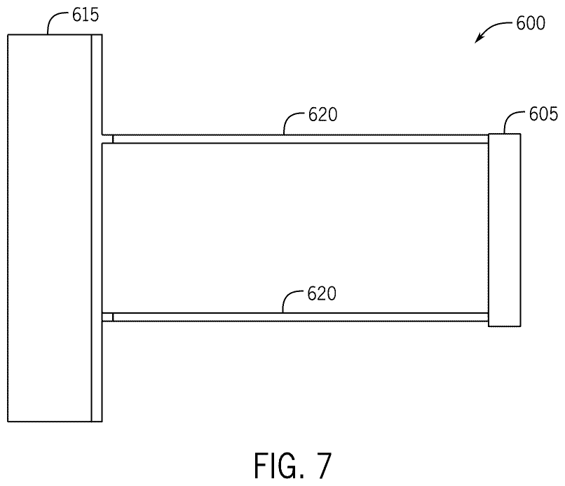

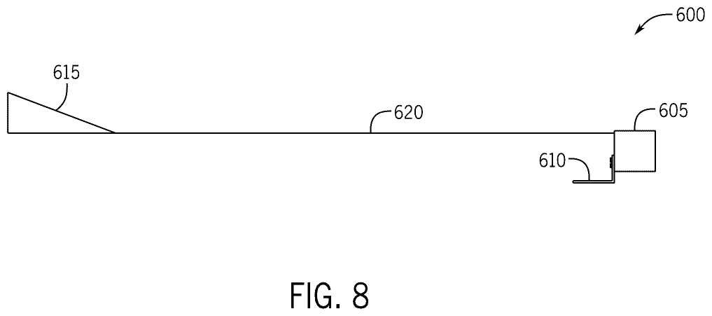

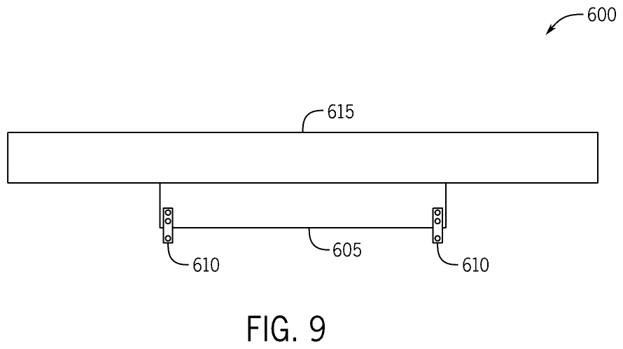

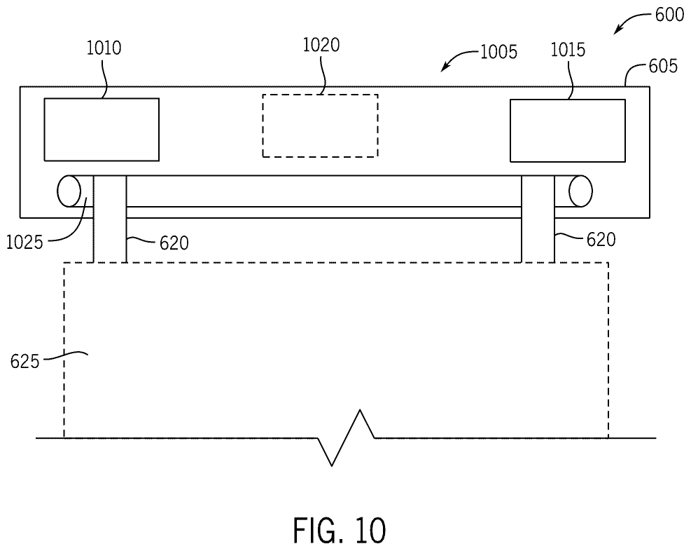

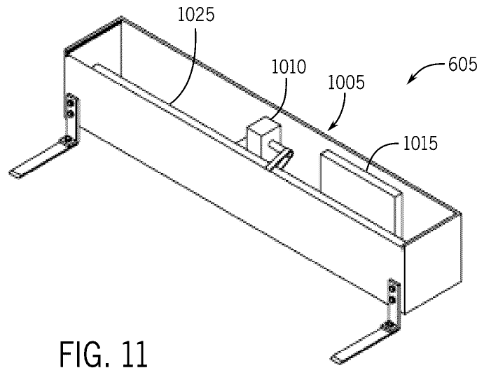

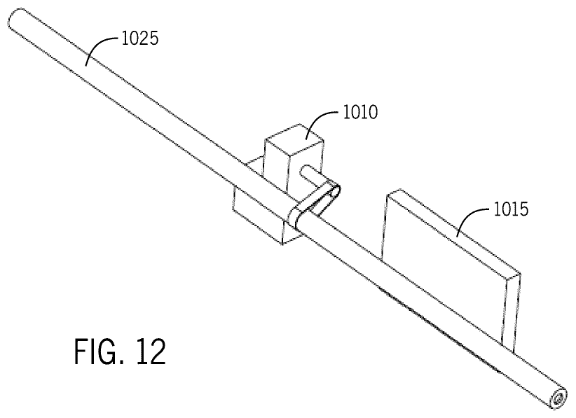

FIGS. 6-12 illustrate another example of a patient transport device 600 that can be used as an alternative configuration of the patient transport device 100. As will be recognized, the patient transport device 600 may operate in a similar fashion to the examples illustrated and described previously. For the sake of brevity, these common features will not be again described below in detail.

In one example, the patient transport device 600 may include a housing 605 having one or more brackets 610 extending away from the housing 605. The brackets 610 may be configured to latch to the side of a bed or other location to secure the patient transport device 600 in position during use (e.g., when transporting a patient). In some examples, the brackets 610 may be adjustable to account for variances in bed (e.g., mattress) thicknesses. Alternatively or additionally, the brackets 610 may be configured to integrate into a stretcher to permit the patient transport device 600 to be secured to the stretcher used by healthcare professionals.

In some examples, an interior portion 1005 of the housing 605 may include a powertrain having a motor 1010 configured to rotate an axle 1025 in response to an input from an operator. In some examples, the powertrain may further include one or more gears, which may be configured to increase a torque output of the motor 1010. The motor 1010 may be configured to rotate the axle 1025 in response to a command from a controller. In some examples, to command the motor 1010, the housing 605 may include one or more buttons. In other examples, to command the motor 1010, the housing 605 may be wirelessly connected to a remote control device, which may be used to command the motor 1010.

In some examples, the interior portion 1005 may further include a pump 1020 arranged within the interior portion 1005. The pump 1020 may be connected via tubing to a ramp 615 in order to actuate the ramp 615 between a deflated position and an inflated position. Further, the pump 1020 may be activated via the one or more buttons or the remote control device described previously. A s should be appreciated, in some examples, the pump 1020 may be located externally to or separate from the interior portion 1005 (e.g., the pump 1020 may be a separate device).

In some examples, to power the motor 1010 (and the pump 1020), the patient transport device 600 may include one or more batteries 1015. The batteries 1015 may be in the form of rechargeable battery packs, which may be swapped in and out during use of the patient transport device 600. Thus, the patient transport device 600 may not rely on a wall plug or other wired power connection. However, in some examples, the patient transport device 600 may include an option to use a wired power source in addition to the batteries 1015.

In use, the patient transport device 600 may include a pair of straps 620 that may be secured to the axle 1025 and extend from the axle 1025 to the ramp 615. In one example use, an operator may apply a force to the ramp 615 to extend the ramp 615 away from the housing 605 via the straps 620 (e.g., as shown by arrow 630), which may rotate the axle 1025 in a first direction. In another example, the operator may engage the motor 1010 to rotate the axle 1025, which may wind the straps 620 around the axle 1025 and draw the ramp 615 towards the housing 605. Thus, the ramp 615 may be extendable away from the housing 605, which lengthens the straps 620. Correspondingly, the ramp 615 may be retractable towards the housing 605, which shortens the straps 620.

In one example, a sheet or other fabric 625 may be secured to the ramp 615 so that an operator may grasp the sheet 625 and pull or move a patient. For example, the sheet 625 may be secured to the ramp 615 via hook-and-loop fasteners, a zipper mechanism, snaps, or other fasteners. Further, when the straps 620 are retracted within the housing 605, the ramp 615 may be detachable from the straps 620 to permit storage of the ramp 615.

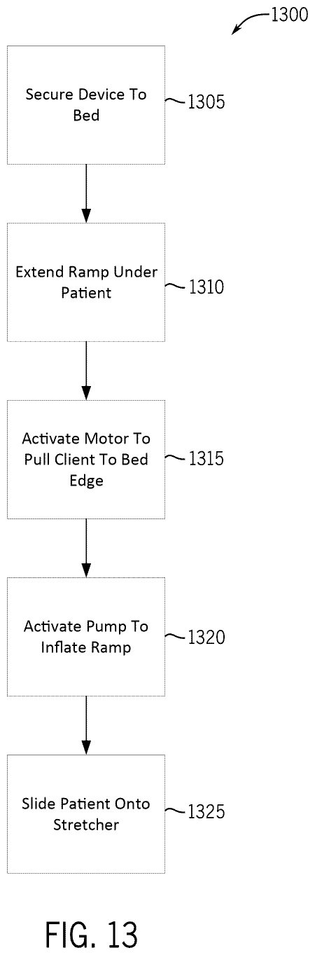

Turning now to FIG. 13, a method 1300 of using the patient transport device 600 is shown. At stage 1305, an operator may secure the patient transport device 600 to the bed via the brackets 610. For example, the brackets 610 may be positioned between the mattress and the bed frame. As mentioned previously, in other examples, the patient transport device 600 may be integrated into a stretcher or other transportation device.

Once the patient transport device 600 is secured to the bed (or other location), at stage 1310, the operator may begin to extend the straps 620 (e.g., pull the straps out of the housing) to position the ramp 615 on a far side of the patient (e.g., opposite the patient from the housing 605). At stage 1315, once the ramp 615 has been positioned underneath the patient, the straps 620 may be retracted towards the housing 605 (e.g., via rotation of the axle 1025) in order to move the patient towards the edge of the bed. As should be appreciated, in some examples, the ramp 615 may be in the deflated position when the patient is being moved towards the edge of the bed.

At stage 1320, once the patient is positioned at the edge of the bed, the pump 1020 may be activated to inflate the ramp 615, which may create an angle in the ramp 615 (e.g., similar to the first position 105 described previously). For example, a second surface of the ramp 615 may begin to rotate with respect to a first surface of the ramp 615. In some examples, the angle of the ramp 615 (e.g., the angle of the second surface with respect to the first surface) may be about 20 degrees. As the ramp 615 inflates, the patient may begin to tilt or rise due to the increase in thickness of one side of the ramp 615 (e.g., to about 6 inches in thickness).

At stage 1325, the operator may utilize the sheet 625 to begin to slide the patient onto the stretcher from the bed. As mentioned previously, due to the effects of gravity, the force needed for the operator to slide the patient may be reduced by approximately half, which may reduce the risk of injury to the operator.

In some examples, the ramp 615 may be sized to extend from about the head of a patient to about the feet of a patient to provide support during patient transport. In one particular example, the ramp 615 may be approximately 74 inches long and have a width of approximately 16 inches. In some examples, the ramp 615 may be made from a pliable polymetric material to provide increased comfort to a patient during use of the patient transport device 600. Additionally, to permit the ramp 615 to reach the far side of a bed or other location, the straps 620 may have an extended length. Further, the extended length of the straps 620 may permit the straps 620 to engage an edge of the bed, which may assist in securing the housing 605 to the bed (e.g., in addition to the brackets 610). In one particular example, the straps 620 may be about 72 inches in length.

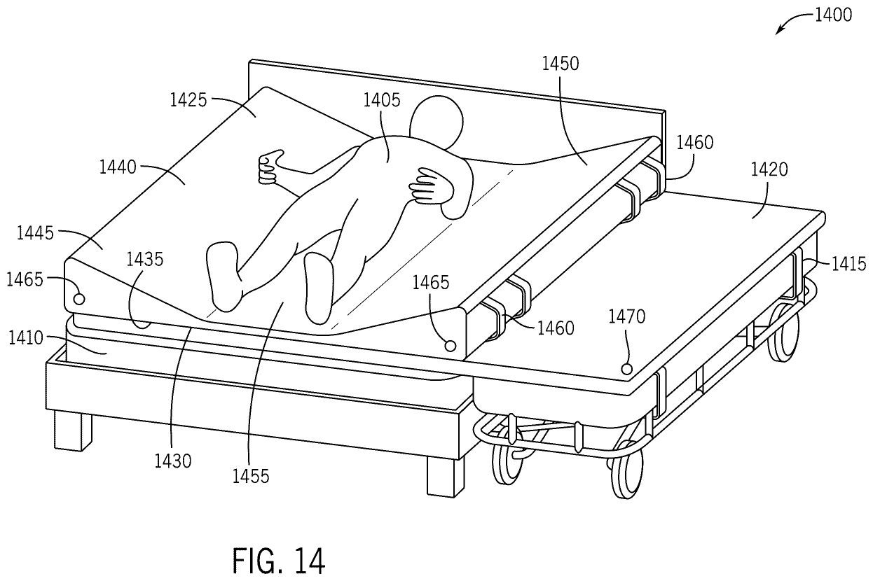

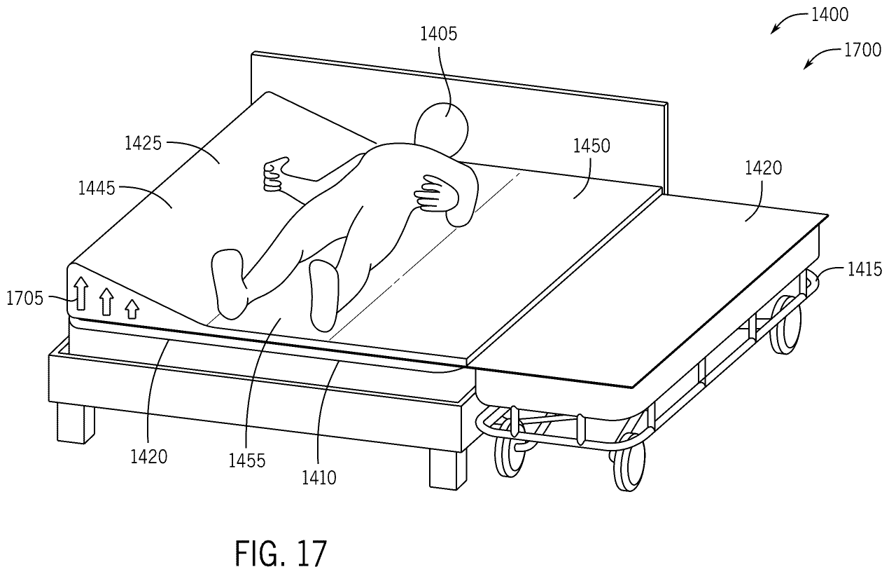

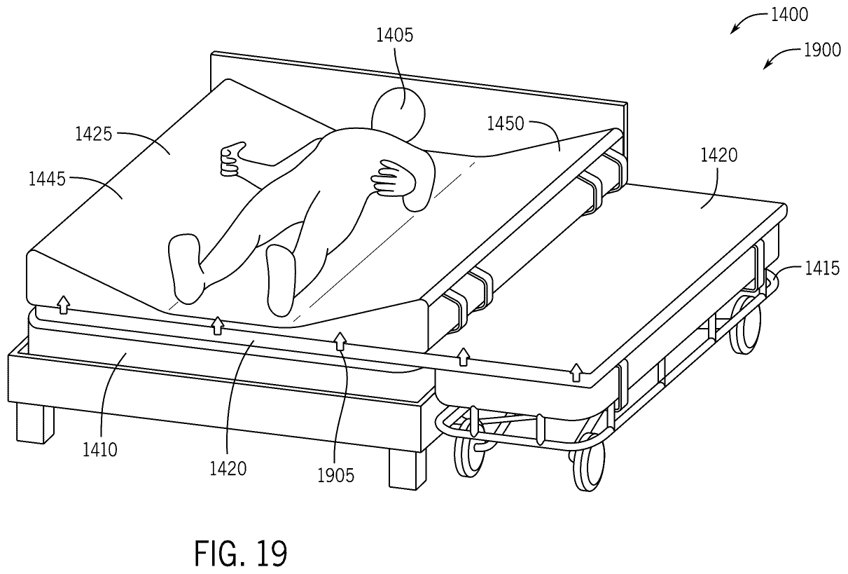

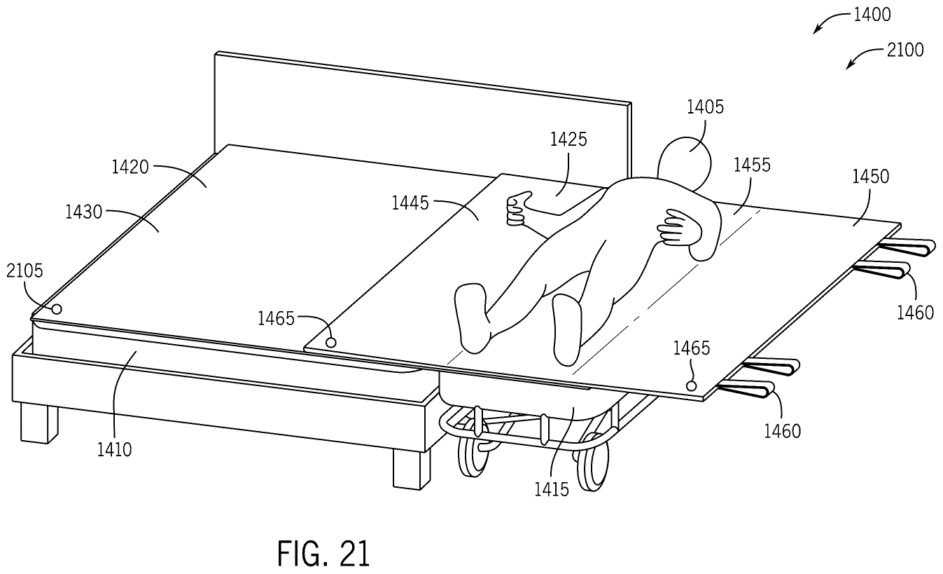

FIGS. 14-21 illustrate an example of a patient transport system 1400. In some examples, the patient transport system 1400 may be used to facilitate the movement of patients between different locations (e.g., between a bed and a stretcher, etc.). For example, looking at FIG. 14, the patient transport system 1400 may be used for transferring a patient 1405 between a first location 1410 (e.g., a bed) and a second location 1415 (e.g., a stretcher). In particular, the patient transport system 1400 may be particularly useful in medical settings (e.g., for EMS, etc.) where moving bariatric patients with limited mobility or in other conditions is necessary. By providing a stable and supportive transfer mechanism, the patient transport system may help reduce the physical strain on healthcare providers and minimize the risk of injury to both patients and caregivers during transfer operations.

In some examples, the patient transport system 1400 may include a transport support 1420 and a transport device 1425, which may be in the form of two separate, discreet components. In some examples, the transport support 1420 may extend between the first location 1410 and the second location 1415, providing a bridge-like structure to support the transport device 1425 throughout the patient transfer process. In some examples, the transport device 1425 may be positioned on top of the transport support 1420 and may be configured to accommodate and support the patient during the transfer.

In some examples, the transport device 1425 may be designed to move along a surface of the transport support 1420 during the patient transport process (e.g., when moving the patient from the first location 1410 to the second location 1415). For example, a first surface 1430 of the transport support 1420 may be in contact with a first surface 1435 of the transport device 1425 so that the transport device 1425 can slide across the transport support 1420. In some cases, the surfaces 1430, 1435 of the transport support 1420 and the transport device 1425 may be made of a material that reduces friction (e.g., Teflon, polymeric materials, etc.). This low-friction material may facilitate movement of the transport device 1425 along the transport support 1420 during transfer operations. In some cases, the use of reduced-friction materials may help minimize the effort required to move patients between the first location 1410 and the second location 1415.

In some examples, to facilitate movement of the transport device 1425 (e.g., across the transport support, etc.), the transport device 1425 may include one or more handles 1460. The handles 1460 may facilitate movement and control of the transport device 1425 during transfer operations. For example, the handles 1460 may permit healthcare providers to guide and maneuver the transport device 1425 along the transport support 1420 between the first location 1410 and the second location 1415.

In some cases, in order to retain the patient 1405 on the transport device 1425 during movement between the first location 1410 and the second location 1415, the transport device 1425 may include one or more inflatable chambers (e.g., ramps), which, when inflated, may form a valley (e.g., a threshold) between the chambers configured to retain the patient during movement (e.g., between the first location and the second location). For example, the transport device 1425 may include a first chamber 1445 and a second chamber 1450 separated by a threshold 1455. In use, the first chamber 1445 and the second chamber 1450 may be designed to provide support and stability for the patient during transfer. For example, a panel 1520 (e.g., surface) of the first and second chambers 1445, 1450 may form an angle 1525 with respect to the first surface 1435 of the transport device 1425. Thus, when inflated, the angle 1525 formed by the panels 1520 may define a valley (e.g., including the threshold) between the chambers to retain the patient. In some examples, the angle 1525 formed by the panels 1520 may be between about 15 and about 80 degrees. In other examples, when deflated, the panels 1520 may not form an angle and may instead be oriented substantially parallel with the first surface 1435 of the transport device 1425. In some cases, each of the chambers 1445, 1450 may be independently inflatable, with the threshold (e.g., between the chambers) not being inflatable and remaining parallel with the first surface 1435 of the transport device.

In some examples, in order to inflate the first and second chambers 1445, 1450, the first and second chambers may each include a port 1465. Thus, in use, a user may inflate or deflate the chambers via the ports 1465 (e.g., via a manual pump, powered pump, or other device). Correspondingly, in some examples, the transport support 1420 may also be inflatable. Thus, the transport support 1420 may include a port 1470 to permit a user to inflate or deflate the transport support 1420.

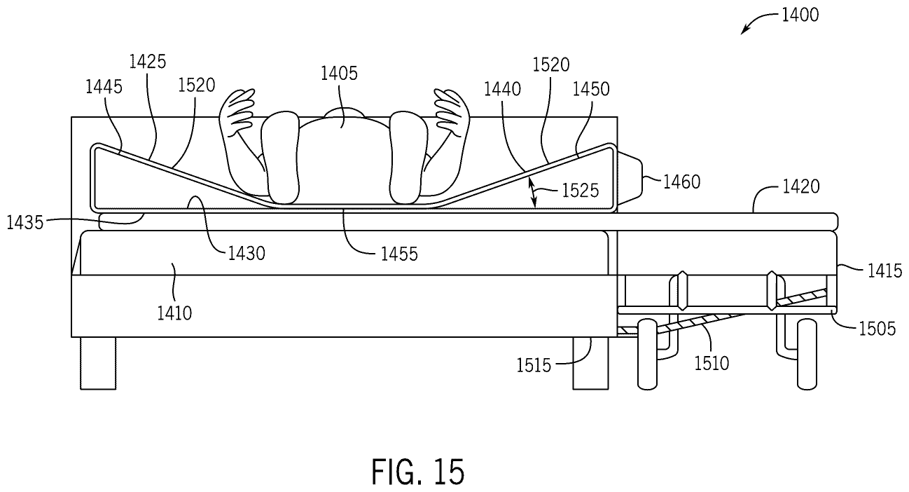

As shown in FIG. 15, the patient transport system 1400 may further include a retention system 1510 configured to secure the transport support 1420 into position (e.g., to mitigate sliding of the transport support during a movement operation). In some examples, the retention system 1510 may be secured to a frame 1505 of the second location (e.g., a frame of a stretcher, gurney, etc.). In other examples, the retention system 1510 may be secured to a frame 1515 of the first location (e.g., a frame of a bed, etc.).

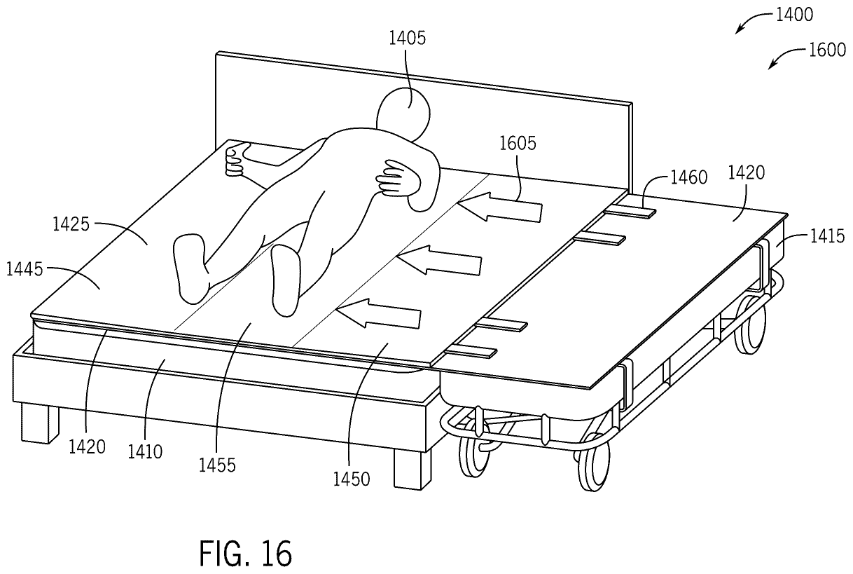

In some examples, the patient transport system 1400 may be designed to facilitate a multi-stage transfer process for moving a patient between the first location 1410 and the second location 1415. For example, FIGS. 16-21 illustrate an example of a patient transfer process using the patient transport system 1400.

In some examples, at stage 1600, the transport support 1420 may be positioned underneath the patient 1405 (e.g., in the direction shown by arrows). Following this, the transport device 1425 may be positioned on top of the transport support 1420 (e.g., by sliding the transport device across the transport support). In some examples, the transport support 1420 may be arranged so that the transport support 1420 extends between the first location 1410 and the second location 1415, providing a stable platform for the transfer operation. Further, the transport device 1425 may be arranged so that the patient 1405 is arranged on the threshold 1455 of the transport device 1425 (e.g., between the chambers 1445, 1450). In some examples, to facilitate insertion of the transport support 1420 and the transport device 1425 under the patient, the transport support 1420 and the first and second chambers 1445, 1450 of the transport device 1425 may be deflated. In some cases, the retention system 1510 may be engaged in order to secure the transport support 1420 in place, which may help prevent unwanted movement of the transport support 1420 during the transfer process, enhancing the overall stability and safety of the system.

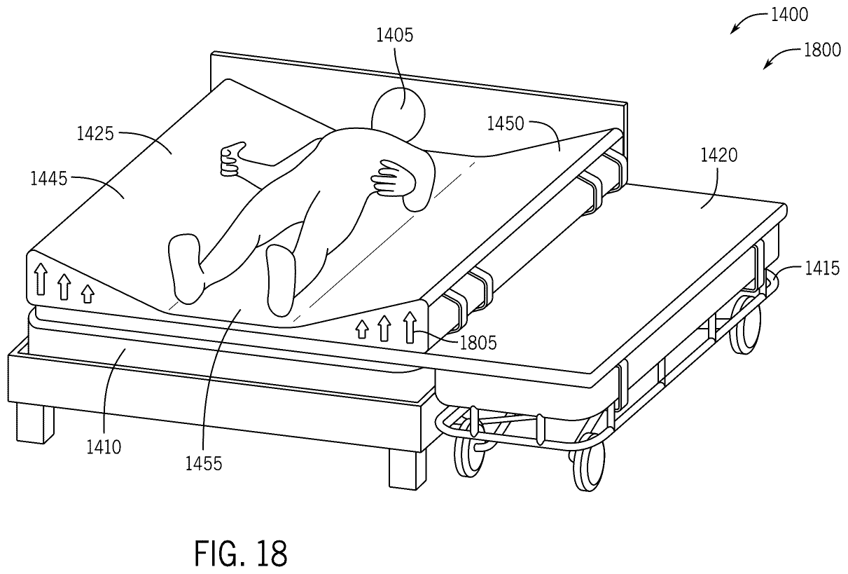

Once the transport support 1420 and the transport device 1425 have been arranged underneath the patient 1405, and prior to movement of the patient, the first and second chambers 1445, 1450 may be inflated via the ports 1465 (e.g., as shown by arrows 1705, 1805). For examples, at stages 1700 and 1800, the chambers 1445, 1450 may be inflated to form an angle 1525 (e.g., a ramp) to secure the patient between the chambers. In some examples, based on the amount of air (or other fluid) added to the chambers, the user may adjust the angle formed by the chambers (e.g., based on the patient needs, etc.). As shown in FIG. 18, once the chambers 1445, 1450 are inflated, the patient 1405 may be secured within the valley formed by the panels 1520 (e.g., on the threshold 1455). As should be appreciated, the angle formed by the chambers 1445, 1450 when inflated may mitigate the risk of the patient 1405 moving, rolling, etc. during the transport process.

In some examples, at stage 1900, as shown by arrows 1905, the transport support 1420 may be inflated via the port 1470. In some examples, inflation of the transport support 1420 may provide a stable platform for the patient 1405 during the transport process (e.g., to mitigate bumps, uneven surfaces, etc. between the first and second locations). Further, the inflated transport support 1420 may help distribute the weight of the patient evenly during the transfer process, which may enhance comfort and stability during the transfer.

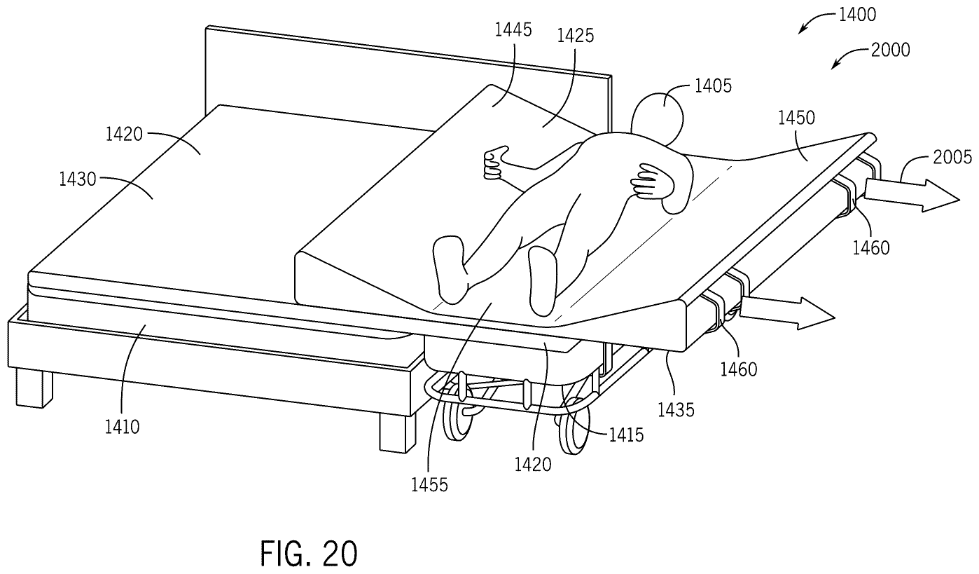

As shown in FIG. 20, in order to move the patient 1405 from the first location 1410 to the second location 1415, a user may grip the handles 1460 and apply a force in the direction shown by arrows 2005. In some examples, the force applied to the handles 1460 may pull the transport device 1425 across the transport support 1420 (e.g., with the first surface of the transport device sliding along the first surface of the transport support). In some examples, during movement of the transport device, the patient may be retained on the threshold 1455 via the panels 1520 (e.g., the inflated chambers 1445, 1450) in order to mitigate movement of the patient.

In some examples, once the patient has been moved into position (e.g., onto second location, etc.), the user may deflate the transport support 1420 via the port 1470 or a secondary port 2105 (e.g., on an opposite side of the transfer support from the port 1470). In some examples, the user may further deflate the chambers 1445, 1450 of the transport device 1425 via the ports 1465. Thus, once deflated, the user may be able to wrap-up or otherwise store the transport device 1425 and transport support 1420 during movement of the patient (e.g., within an ambulance or other vehicle, etc.). Further, when deflated, the transport device 1425 and transport support 1420 may be stored in a relatively small area due to the compressible form factor, which may be desirable to a user.

In some examples, once the patient has been moved to a new location (e.g., a hospital, etc.) the transport support 1420 and transport device 1425 may be reinflated and used to move the patient into position (e.g., onto the bed, or other location). Following this, the transport support 1420 and transport device 1425 may be removed from underneath the patient and stored for later use.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A patient transport system, comprising:
a transport support extending between a first location and a second location;
a transport device positioned on the transport support, the transport device to slide along a surface of the transport support between the first location and the second location, the transport device including:
a first inflatable chamber;
a second inflatable chamber; and
a threshold arranged between the first and second inflatable chambers, the threshold to retain a patient between the first and second inflatable chambers during movement of the transport device along the surface of the transport support, between the first location and the second location.

2. The patient transport system of claim 1, wherein the transport support is inflatable.

3. The patient transport system of claim 1, wherein the transport device further includes:
handles attached to the transport device to facilitate movement of the transport device along the transport support.

4. The patient transport system of claim 1, wherein the first and second inflatable chambers each include a panel forming an angle with respect to a surface of the transport device when inflated.

5. The patient transport system of claim 4, wherein the angle formed by the panels is between about 15 and about 60 degrees when the chambers are inflated.

6. The patient transport system of claim 1, further comprising:
a retention system to secure the transport support to at least one of the first location or the second location.

7. The patient transport system of claim 1, wherein the transport device includes a surface material configured to reduce friction between the surface of the transport device and the surface of the transport support.

8. The patient transport system of claim 1, wherein the first inflatable chamber and the second inflatable chamber are independently inflatable.

9. The patient transport system of claim 8, wherein each of the first inflatable chamber and the second inflatable chamber includes a port permit inflation and deflation of the respective chamber.

10. A method of transferring a patient between a first location and a second location, the method comprising:
positioning a transport support beneath the patient, the transport support extending between the first location and the second location;
placing a transport device on the transport support, beneath the patient, the transport device having first and second inflatable chambers separated by a threshold;
positioning the patient on the threshold of the transport device;
inflating the first and second chambers to secure the patient within a valley formed between the first and second chambers; and
sliding the transport device along a surface of the transport support from the first location to the second location.

11. The method of claim 10, further comprising:
inflating the transport support prior to moving the transport device.

12. The method of claim 10, further comprising:
securing the transport support to at least one of the first location or the second location using a retention system.

13. The method of claim 10, wherein moving the transport device includes:
gripping one or more handles attached to the transport device; and
applying a force to slide the transport device along the surface of the transport support.

14. The method of claim 10, further comprising:
deflating the first and second chambers and the transport support after moving the transport device to the second location.

15. The method of claim 10, wherein the first and second chambers each include a panel forming an angle with respect to a surface of the transport device when inflated.

16. The method of claim 15, wherein the angle formed by the panels is between about 15 and about 60 degrees when the chambers are inflated.

17. A patient transport system, comprising:
an inflatable transport support extending between a first location and a second location;
a transport device movably positioned on the inflatable transport support, the transport device including:
a first surface in contact with the inflatable transport support;
first and second independently inflatable chambers; and
a non-inflatable threshold between the first and second inflatable chambers; the threshold to retain a patient between the first and second inflatable chambers during movement of the transport device along the surface of the transport support, between the first location and the second location.

18. The patient transport system of claim 17, wherein the first and second independently inflatable chambers each include a panel forming an angle with respect to the first surface of the transport device when inflated.

19. The patient transport system of claim 18, wherein the angle formed by the panels is between about 15 and about 80 degrees when the chambers are inflated.

20. The patient transport system of claim 17, wherein the transport device includes a surface material configured to reduce friction between the surface of the transport device and the surface of the transport support.
